(19) United States
(12) Patent Application Publication
(10) Pub. No.: US 2026/0188925 A1
(43) Pub. Date: Jul. 2, 2026

(54) CONNECTOR ASSEMBLY

(71) Applicant: BIZLINK INTERNATIONAL CORP., New Taipei City (TW)

(72) Inventors: Jui-Hung CHIEN, New Taipei City (TW); Guang Zong HU, New Taipei City (TW); Weitsemr CHIU, New Taipei City (TW)

(21) Appl. No.: 19/006,234

(22) Filed: Dec. 31, 2024

(51) Int. Cl. H01R 12/53; H01R 12/58; H01R 12/72

(52) U.S. Cl. CPC H01R 12/53; H01R 12/585; H01R 12/722

(57) ABSTRACT

A connector assembly includes a housing, a printed circuit board, a first socket, a first cable module, a second socket and a second cable module. The housing has a first opening, a second opening and a first space. The printed circuit board includes a front portion and a rear portion. The front portion extends through the first opening. The rear portion is in the space. The first socket and the second socket connect with the rear portion. The first cable module includes a first plug and a first cable. The first cable connects with the first plug and extends through the second opening. The first plug connects with the first socket. The second cable module includes a second plug and a second cable. The second cable connects with the second socket and extends through the second opening. The second plug connects with the second socket.

### BACKGROUND

### TECHNICAL FIELD

The present disclosure relates to connector assemblies. More particularly, the present disclosure relates to connector assemblies configured to be connected with the power only connector of a server for transmission of power and lower speed signal.

### DESCRIPTION OF RELATED ART

In the Chinese patent 215299679U, a wire end connector is disclosed. The wire end connector includes a housing, a printed circuit board and a plurality of cables. During the process of assembly, after the cables are first connected to the printed circuit board, molding material is applied to embed at least a portion of the cables and the printed circuit board such that the cables and the printed circuit board are fixed to each other. The molded structure of the cables and the printed circuit board is then moved into the housing. However, after the assembly of the wire end connector is completed, replacement of any cable(s) upon the actual situation will be very difficult due to the presence of the molding material in the housing.

### SUMMARY

The disclosed connector assembly facilitates the replacement of sockets, power cables, and low-speed signal cables. It includes a housing, a printed circuit board (PCB), sockets, plugs, and cables. The housing features openings and a space to accommodate these components. The PCB, partly extending outside the housing, connects to detachable sockets without intermediate molded components, reducing complexity. Plugs and cables connect to the sockets and exit through the openings. This design eliminates the need for welding, lowering assembly time and cost. It also simplifies replacement of individual components, making maintenance efficient and user-friendly.

### BRIEF DESCRIPTION OF THE DRAWINGS

The disclosure can be more fully understood by reading the following detailed description of the embodiments, with reference made to the accompanying drawings as follows:

FIG. 1 is a schematic view of a connector assembly according to an embodiment of the present disclosure;

FIG. 2 is a schematic view of the connector assembly of FIG. 1 in another visual angle;

FIG. 3 is a schematic view of the connector assembly of FIG. 1, in which the housing is omitted;

FIG. 4 is a schematic view of the first socket and the second socket of FIG. 3;

FIG. 5 is a schematic view of the first socket, the second socket and the printed circuit board of FIG. 3, in which the first socket and the second socket are respectively ready to be connected to the printed circuit board;

FIG. 6 is an enlarged sectional view of one of the first terminals inserting into the printed circuit board of FIG. 5;

FIG. 7 is an enlarged sectional view of the one of the second terminals inserting into the printed circuit board of FIG. 5;

FIG. 8 is a schematic view of the first cable module and the second cable module of FIG. 3;

FIG. 9 is a schematic view of the connector assembly of FIG. 3, in which the first cable module is ready to be connected to the first socket, and the second cable module is ready to be connected to the second socket;

FIG. 10 is a schematic view of the connector assembly of FIG. 1, in which the printed circuit board already disposed with the first cables and the second cables is ready to be connected to the first subsidiary body; and

FIG. 11 is a schematic view of the connector assembly of FIG. 1, in which the second subsidiary body is ready to be connected to the first subsidiary body.

### DETAILED DESCRIPTION

Drawings will be used below to disclose embodiments of the present disclosure. For the sake of clear illustration, many practical details will be explained together in the description below. However, it is appreciated that the practical details should not be used to limit the claimed scope. In other words, in some embodiments of the present disclosure, the practical details are not essential. Moreover, for the sake of drawing simplification, some customary structures and elements in the drawings will be schematically shown in a simplified way. Wherever possible, the same reference numbers are used in the drawings and the description to refer to the same or like parts.

Unless otherwise defined, all terms (including technical and scientific terms) used herein have the same meanings as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

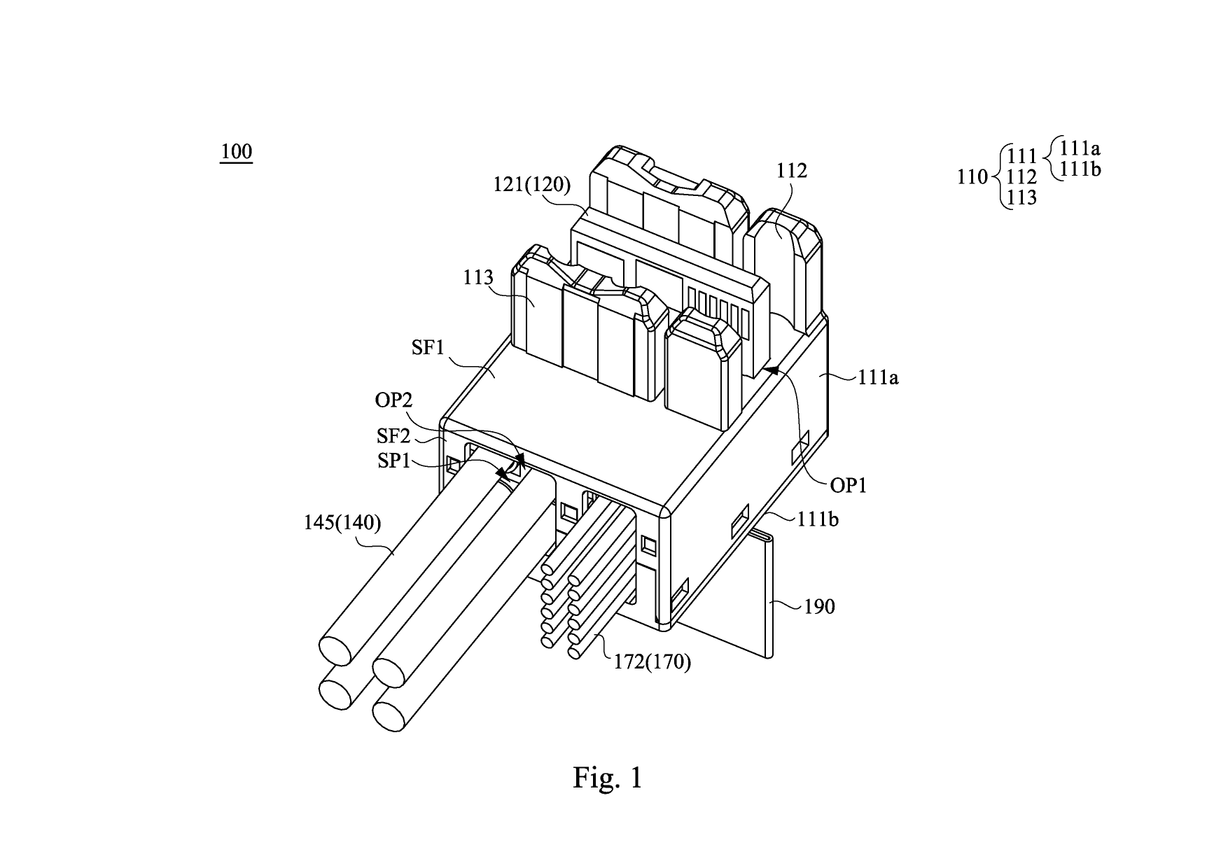

FIGS. 1-11 are drawn according to the actual scale. For the sake of concise description in this specification, the scales of the elements are not listed one by one. However, the scale and position of each element should be regarded as part of the scope of this specification.

As shown in FIGS. 1-11, a connector assembly 100 is provided in the present disclosure. Moreover, for example, the connector assembly 100 is utilized for connection with the power only connector of a server for transmission of power and lower speed signal.

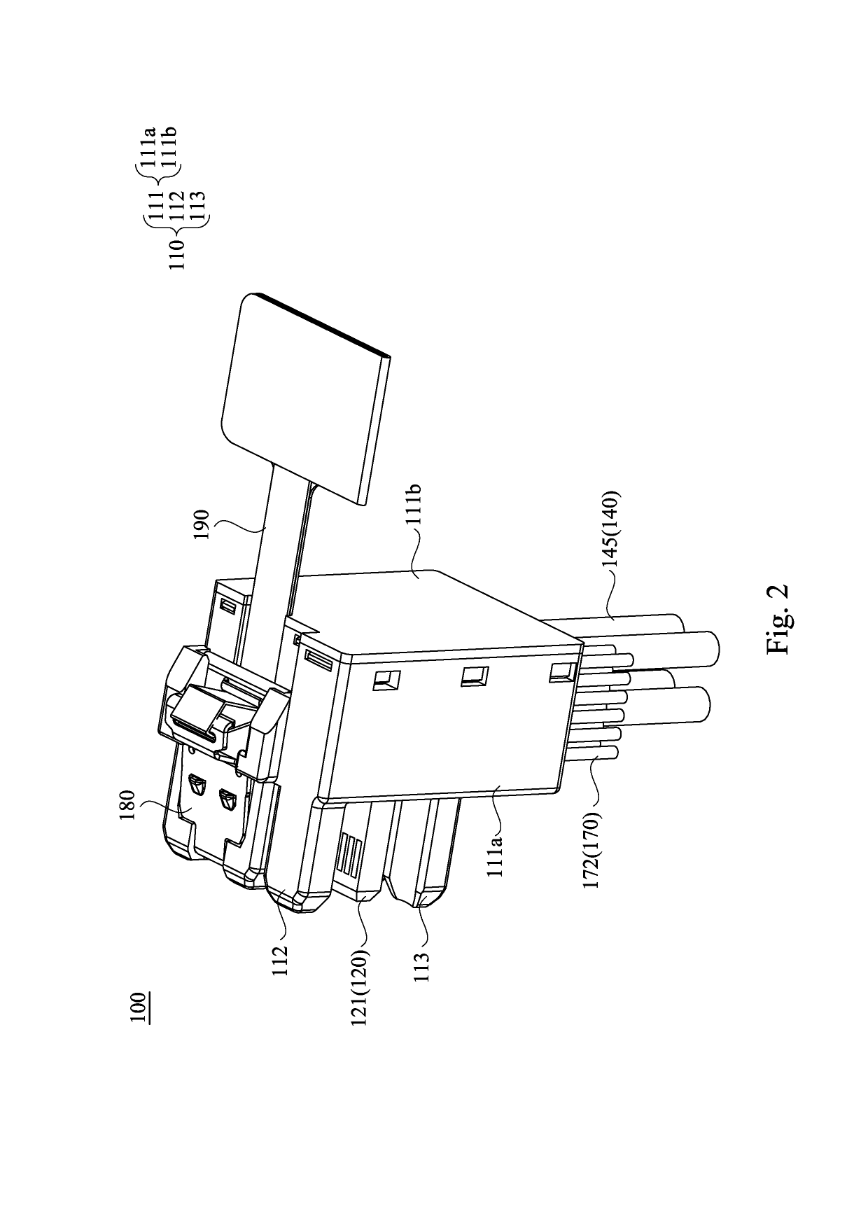

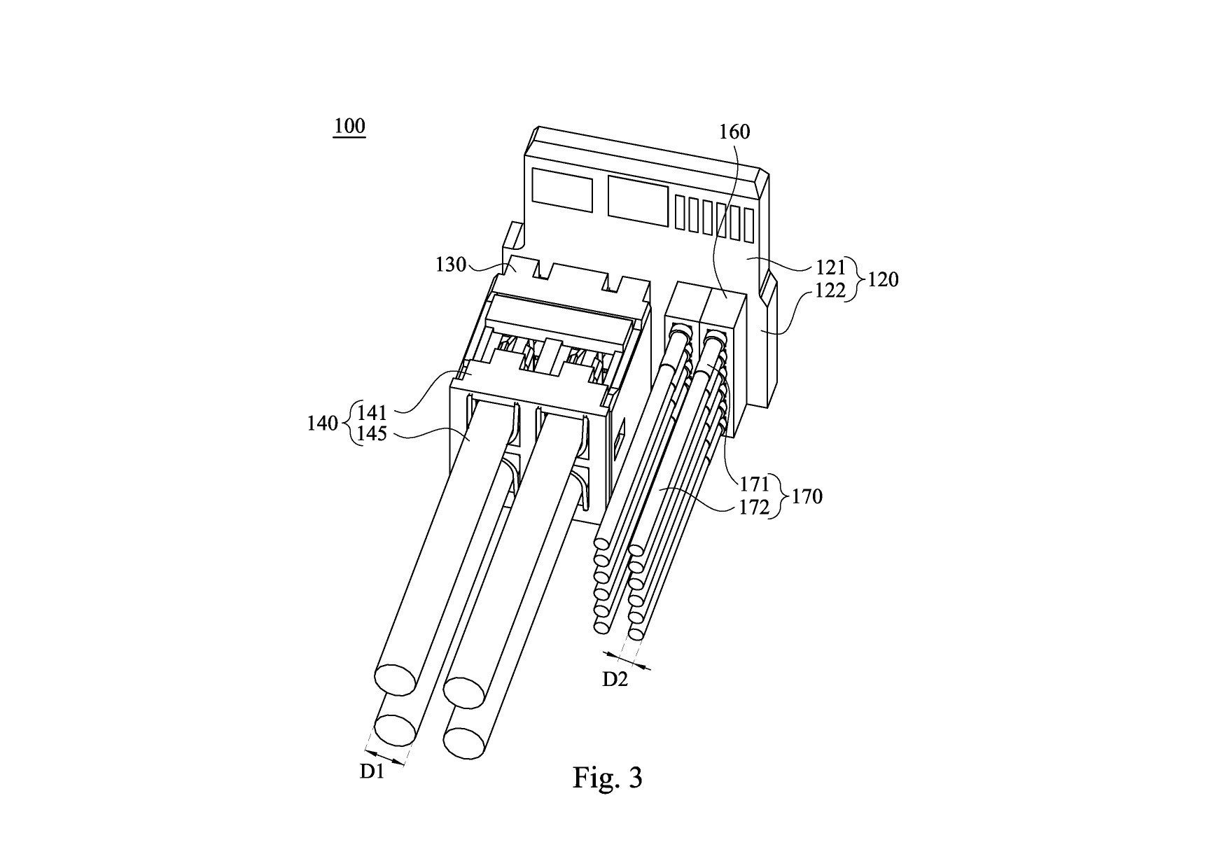

FIG. 1 is a schematic view of a connector assembly 100 according to an embodiment of the present disclosure. FIG. 2 is a schematic view of the connector assembly 100 of FIG. 1 in another visual angle. FIG. 3 is a schematic view of the connector assembly 100 of FIG. 1, in which the housing 110 is omitted. In this embodiment, as shown in FIGS. 1-3, a connector assembly 100 includes a housing 110, a printed circuit board 120, a first socket 130, a first cable module 140, a second socket 160, a second cable module 170, a latch 180 and a pull tab 190, in which the first socket 130 and the second socket 160 are seen on FIG. 3.

In practical applications, each of the first cables 145 is a power cable, while each of the second cables 172 is a low-speed signal cable, in which the power cable is thicker than the low-speed signal cable. To be specific, as shown in FIG. 3, each of the first cables 145 has a first diameter D1, while each of the second cables 172 has a second diameter D2. In this embodiment, the first diameter D1 of each of the first cables 145 is at least two times larger than the second diameter D2 of each of the second cables 172.

Furthermore, as shown in FIGS. 1-2, the housing 110 includes a main body 111, a first insertion portion 112 and a second insertion portion 113. The main body 111 has a first outer surface SF1, a second outer surface SF2, a first opening OP1, a second opening OP2 and a first space SP1. The first outer surface SF1 is adjacent and substantially perpendicular to the second outer surface SF2. The first opening OP1 is located on the first outer surface SF1. The second opening OP2 is located on the second outer surface SF2. The first outer surface SF1 and the second outer surface SF2 together defining the first space SP1. The first space SP1 is spatially communicated with the first opening OP1 and the second opening OP2. The first insertion portion 112 and the second insertion portion 113 are respectively disposed on the first outer surface SF1 of the main body 111. The first opening OP1 is located between the first insertion portion 112 and the second insertion portion 113. The latch 180 is connected with the first insertion portion 112. The pull tab 190 is connected with the latch 180 and configured to be pulled to elastically deform the latch 180.

To be specific, as shown in FIGS. 1-2, the main body 111 includes a first subsidiary body 111a and a second subsidiary body 111b. The first subsidiary body 111a has the first outer surface SF1 and defines the first space SP1. The second subsidiary body 111b is detachably connected with the first subsidiary body 111a to at least partially enclose the first space SP1. The first subsidiary body 111a and the second subsidiary body 111b together define the second outer surface SF2 and the second opening OP2 therebetween.

In addition, as shown in FIGS. 1-3, the printed circuit board 120 includes a front portion 121 and a rear portion 122. The rear portion 122 is connected with the front portion 121. The front portion 121 extends out of the housing 110 through the first opening OP1 and the rear portion 122 is disposed in the first space SP1 of the housing 110. Moreover, the first insertion portion 112 and the second insertion portion 113 are respectively spaced apart from the front portion 121 of the printed circuit board 120.

Moreover, as shown in FIGS. 1-3, the first socket 130 is disposed in the first space SP1 of the housing 110 and detachably connected with the rear portion 122 of the printed circuit board 120. The first cable module 140 includes a first plug 141 and a plurality of first cables 145. Each of the first cables 145 is connected with the first plug 141 and extends out of the housing 110 through the second opening OP2. The first plug 141 is detachably connected with the first socket 130. The second socket 160 is disposed in the first space SP1 of the housing 110 and detachably connected with the rear portion 122 of the printed circuit board 120. The second cable module 170 includes a plurality of second plugs 171 and a plurality of second cables 172. Each of the second cables 172 is connected with a corresponding one of the second plugs 171 and extends out of the housing 110 through the second opening OP2. The second plugs 171 are respectively and detachably connected with the second socket 160. The first socket 130 and the second socket 160 are spaced apart from each other. This means the first socket 130 and the second socket 160 do not directly contact with each other.

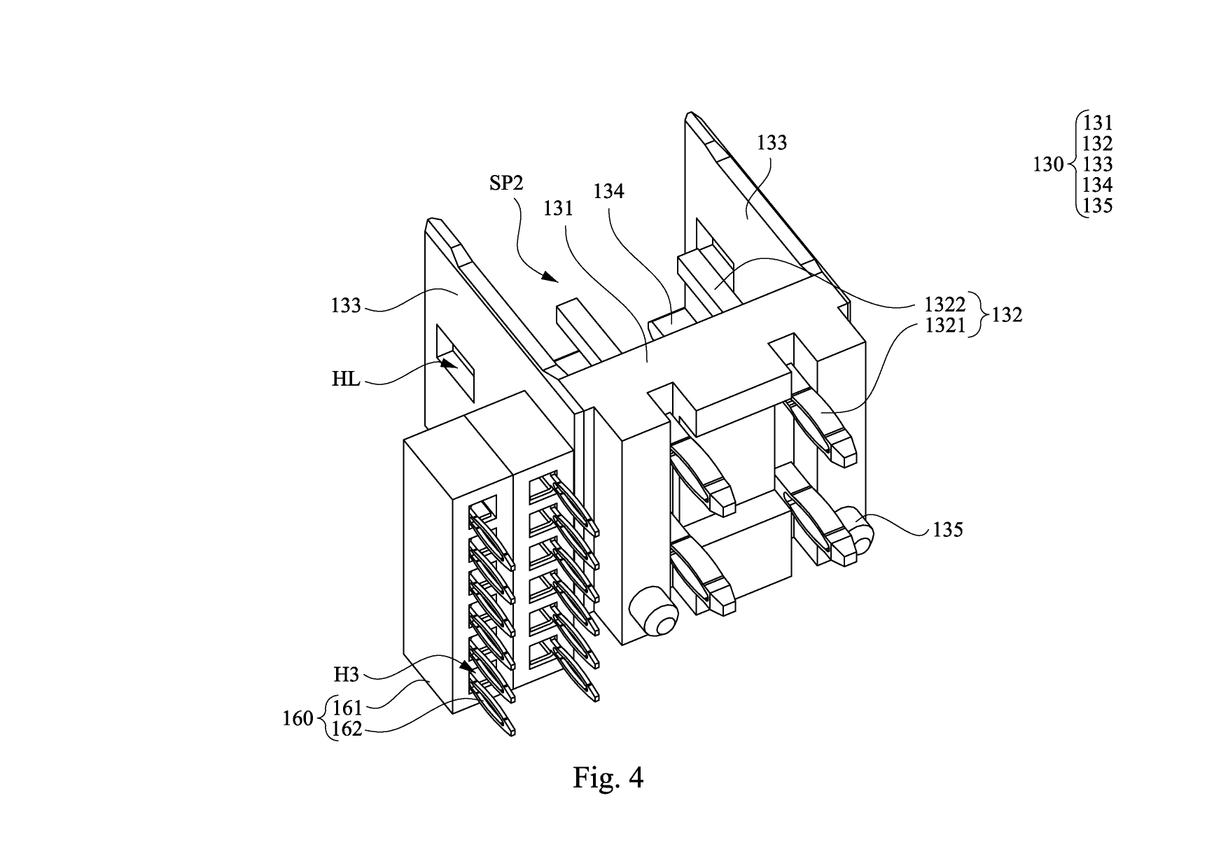

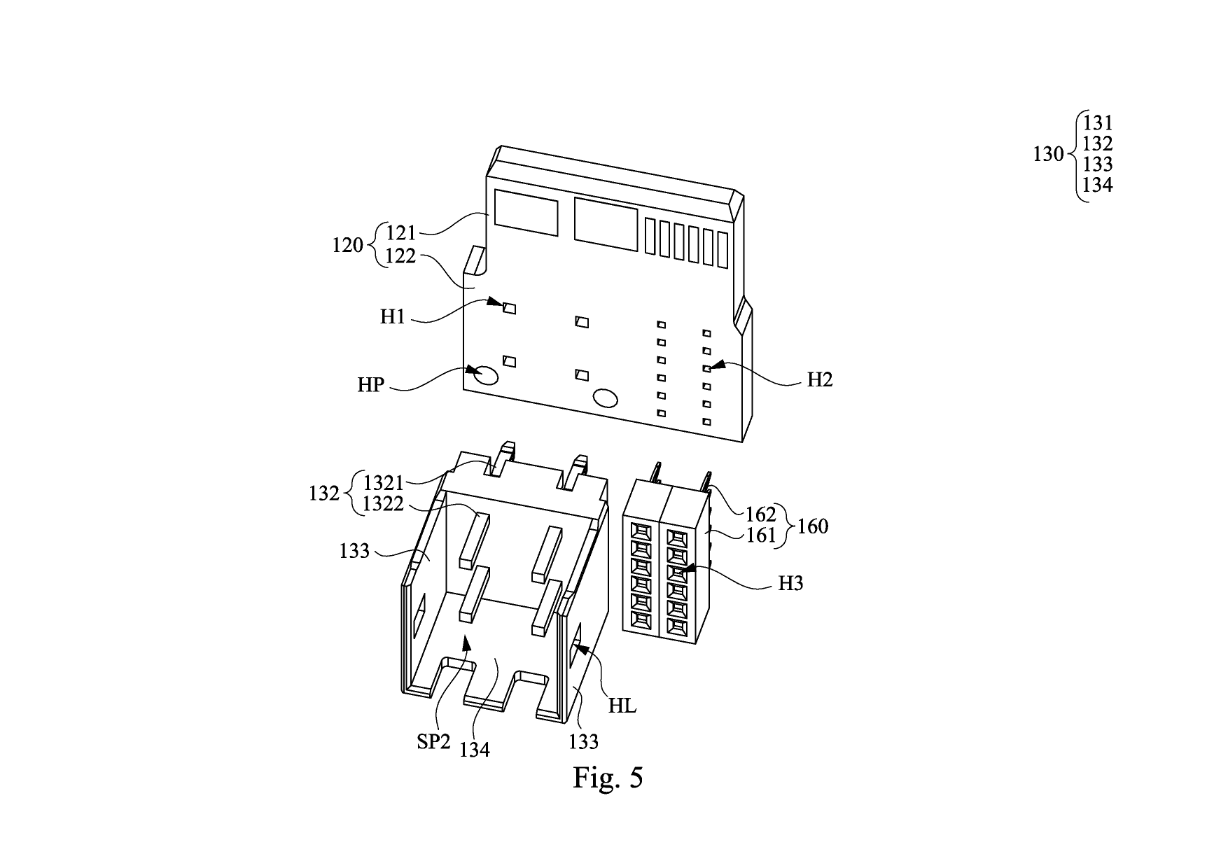

Reference is made to FIGS. 4-5. FIG. 4 is a schematic view of the first socket 130 and the second socket 160 of FIG. 3. FIG. 5 is a schematic view of the first socket 130, the second socket 160 and the printed circuit board 120 of FIG. 3, in which the first socket 130 and the second socket 160 are respectively ready to be connected to the printed circuit board 120. In this embodiment, as shown in FIGS. 4-5, the first socket 130 includes a first base 131, a plurality of first terminals 132, two first sidewalls 133, a second sidewall 134 and a plurality of positioning protrusions 135. The first terminals 132 penetrate through the first base 131. Each of the first terminals 132 includes a first end section 1321 and a second end section 1322. The second end section 1322 is opposite to the first end section 1321. The second end section 1322 is configured to insert into the first plug 141 and be detachably connected with a corresponding one of the first cables 145. The first sidewalls 133 are connected with the first base 131. The first sidewalls 133 are opposite to each other. Each of the first sidewalls 133 has at least one locking hole HL thereon. The second sidewall 134 is connected with the first base 131 and connected between the first sidewalls 133. The first sidewalls 133 and the second sidewall 134 are arranged to at least partially form a U-shape. The first base 131, the first sidewalls 133 and the second sidewall 134 together define a second space SP2. The positioning protrusions 135 are disposed on a side of the first base 131 away from the second space SP2.

On the other hand, as shown in FIGS. 4-5, the second socket 160 includes a second base 161 and a plurality of second terminals 162. The second base 161 has a plurality of third through holes H3. Each of the second terminals 162 is configured to be detachably connected with a corresponding one of the second plugs 171 in a corresponding one of the third through holes H3 of the second base 161.

Correspondingly, as shown in FIG. 5, the rear portion 122 of the printed circuit board 120 has a plurality of first through holes H1, a plurality of second through holes H2 and a plurality of positioning holes HP. The first end section 1321 of each of the first terminals 132 is configured to insert into a corresponding one of the first through holes H1 to secure with the rear portion 122. Each of the second terminals 162 is configured to insert into a corresponding one of the second through holes H2 to secure with the rear portion 122. The positioning protrusions 135 of the first socket 130 are configured to insert into the positioning holes HP for positioning.

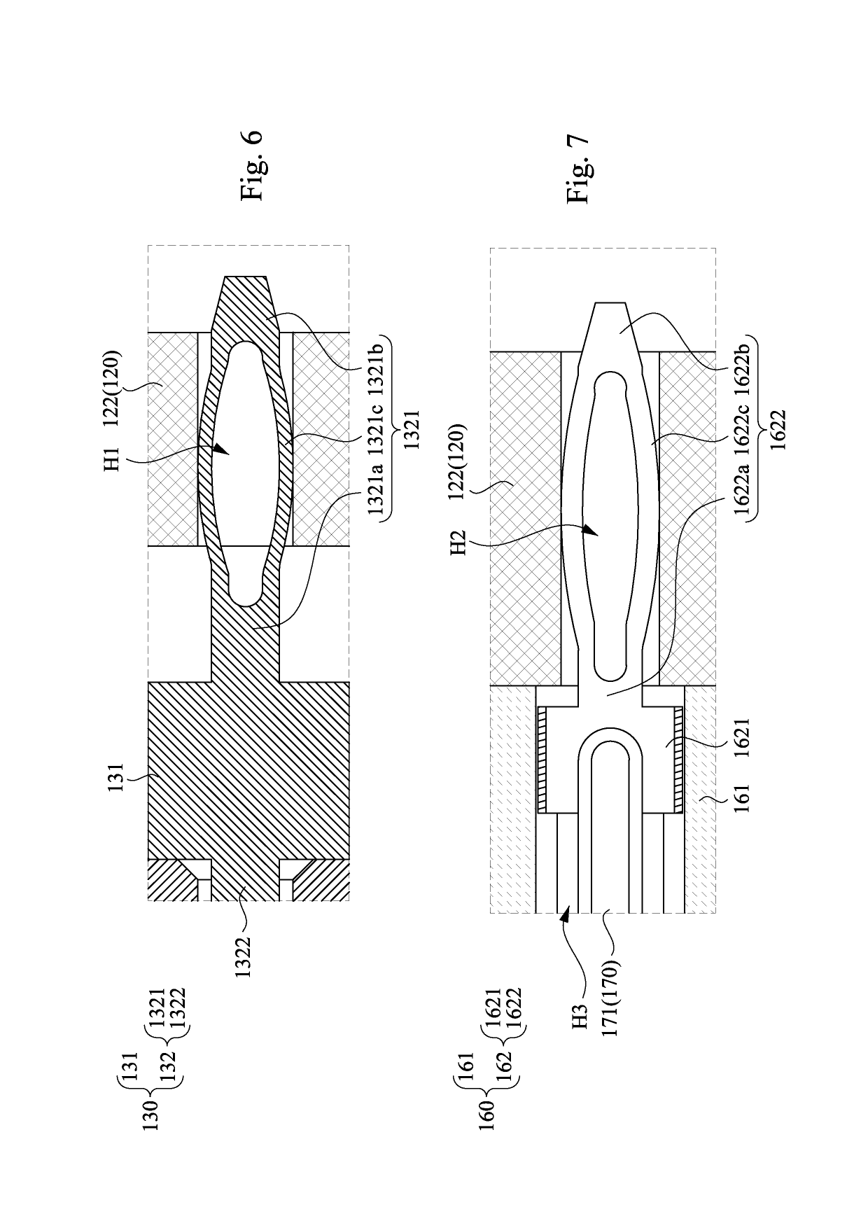

Reference is made to FIG. 6. FIG. 6 is an enlarged sectional view of one of the first terminals 132 inserting into the printed circuit board 120 of FIG. 5. As shown in FIG. 6, when the first end section 1321 of each of the first terminals 132 is inserted into the rear portion 122 of the printed circuit board 120, the first base 131 of the first socket 130 abuts against the rear portion 122 of. Moreover, the first end section 1321 of each of the first terminals 132 includes a first root 1321a, a first tip 1321b and two first curved arms 1321c. The first root 1321a is connected to a corresponding one of the second end sections 1322. The first curved arms 1321c are respectively connected between the first tip 1321b and the first root 1321a. The first curved arms 1321c are curved away from each other to abut against the printed circuit board 120 within a corresponding one of the first through holes H1, such that the first socket 130 is secured to the rear portion 122 of the printed circuit board 120.

Reference is made to FIG. 7. FIG. 7 is an enlarged sectional view of the one of the second terminals 162 inserting into the printed circuit board 120 of FIG. 5. As shown in FIG. 7, when each of the second terminals 162 is inserted into the rear portion 122 of the printed circuit board 120, the second base 161 of the second socket 160 abuts against the rear portion 122. Moreover, each of the second terminals 162 includes a fixing portion 1621 and a connecting portion 1622. The fixing portion 1621 is located in a corresponding one of the third through holes H3 of the second base 161 and configured to be detachably connected with a corresponding one of the second plugs 171. The connecting portion 1622 is connected with the fixing portion 1621. The connecting portion 1622 inserts into a corresponding one of the second through holes H2 of the rear portion 122 of the printed circuit board 120.

To be specific, as shown in FIG. 7, each of the connecting portions 1622 includes a second root 1622a, a second tip 1622b and two second curved arms 1622c. The second root 1622a is connected to a corresponding one of the fixing portions 1621. The second curved arms 1622c are respectively connected between the second tip 1622b and the second root 1622a. The second curved arms 1622c are curved away from each other to abut against the printed circuit board 120 within a corresponding one of the second through holes H2, such that the second socket 160 is secured to the rear portion 122 of the printed circuit board 120.

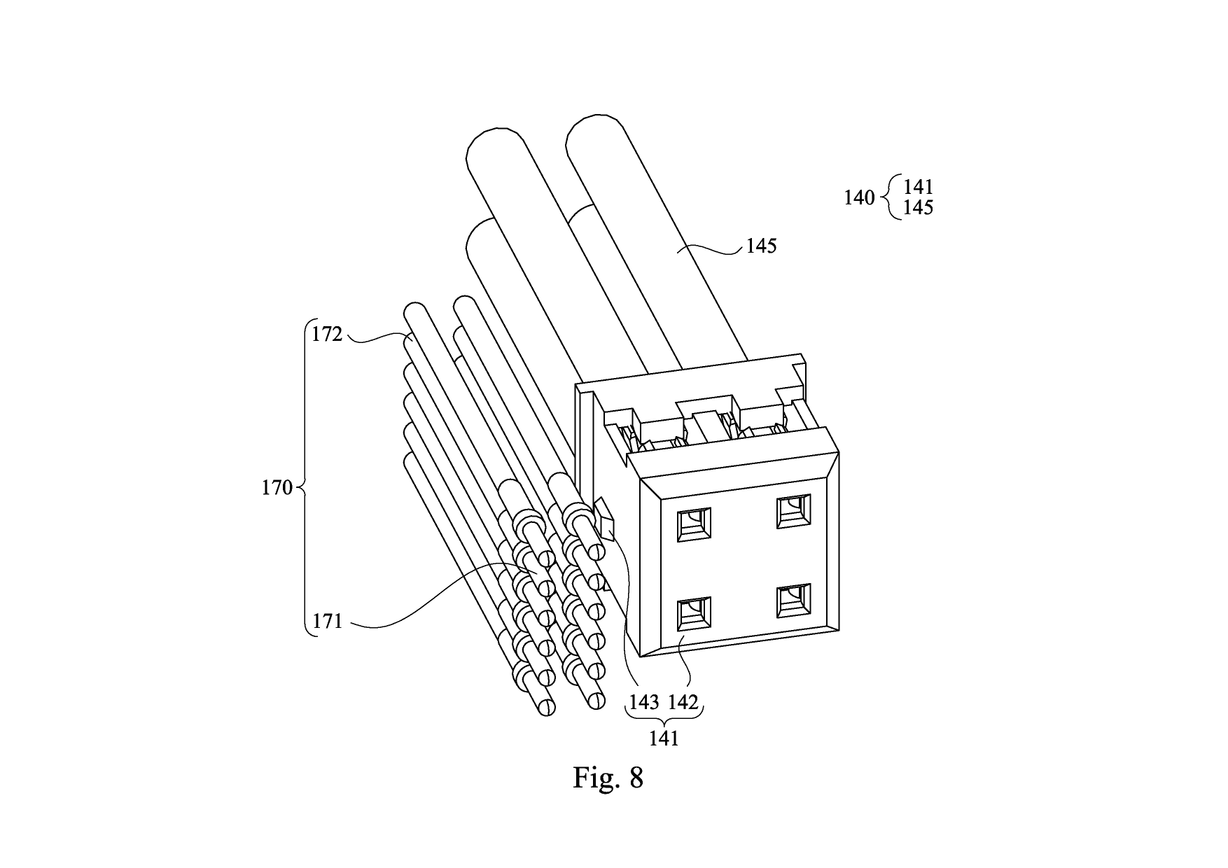

Reference is made to FIG. 8. FIG. 8 is a schematic view of the first cable module 140 and the second cable module 170 of FIG. 3. In this embodiment, as shown in FIG. 8, the first plug 141 of the first cable module 140 includes a main portion 142 and at least a pair of locking protrusions 143. The first cables 145 are connected with the main portion 142, such that an end of each of the first cables 145 is located inside the main portion 142. The locking protrusions 143 are disposed on opposite sides of the main portion 142. On the other hand, the second plugs 171 of the second cable module 170 are spaced apart from each other and are configured to be individually inserted into the third through holes H3 of the second base 161 of the second socket 160.

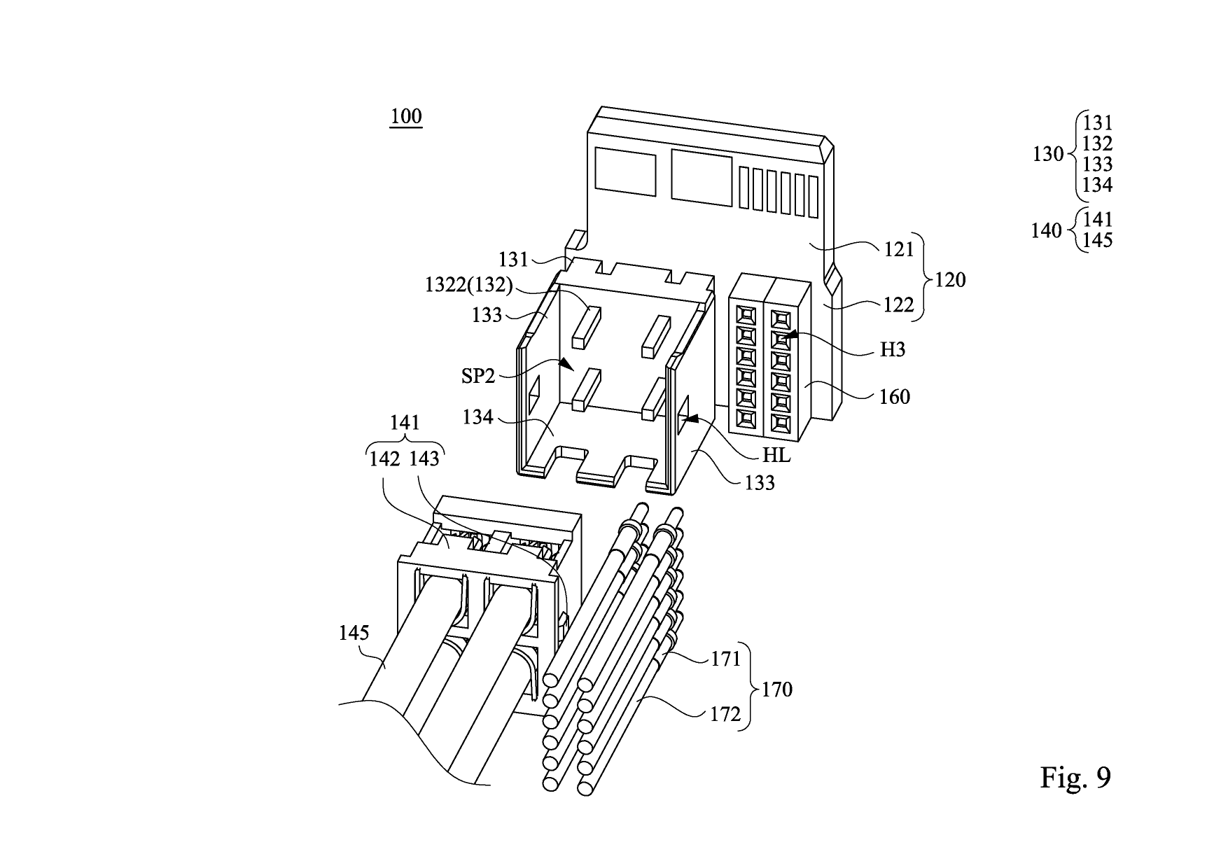

Reference is made to FIG. 9. FIG. 9 is a schematic view of the connector assembly 100 of FIG. 3, in which the first cable module 140 is ready to be connected to the first socket 130, and the second cable module 170 is ready to be connected to the second socket 160. As shown in FIG. 9, after the first socket 130 and the second socket 160 are first connected to the rear portion 122 of the printed circuit board 120, the first cable module 140 is ready to be connected to the first socket 130, and the second cable module 170 is ready to be connected to the second socket 160. When the first cable module 140 is connected to the first socket 130, the second end sections 1322 of the first terminals 132 insert into the main portion 142 of the first plug 141 to detachably connect with the first cables 145. Meanwhile, the second space SP2 defined by the first base 131, the first sidewalls 133 and the second sidewall 134 of the first socket 130 at least partially accommodates the first plug 141. To be specific, the main portion 142 of the first plug 141 abuts against the first base 131, the first sidewalls 133 and the second sidewall 134. In addition, each of the locking protrusions 143 of the first plug 141 snaps into a corresponding one of the locking holes HL of the first sidewalls 133 for security. On the other hand, when the second cable module 170 is connected to the second socket 160, the second plugs 171 insert into the third through holes H3 of the second socket 160 and detachably connect with the fixing portions 1621 of the second terminals 162, as described above.

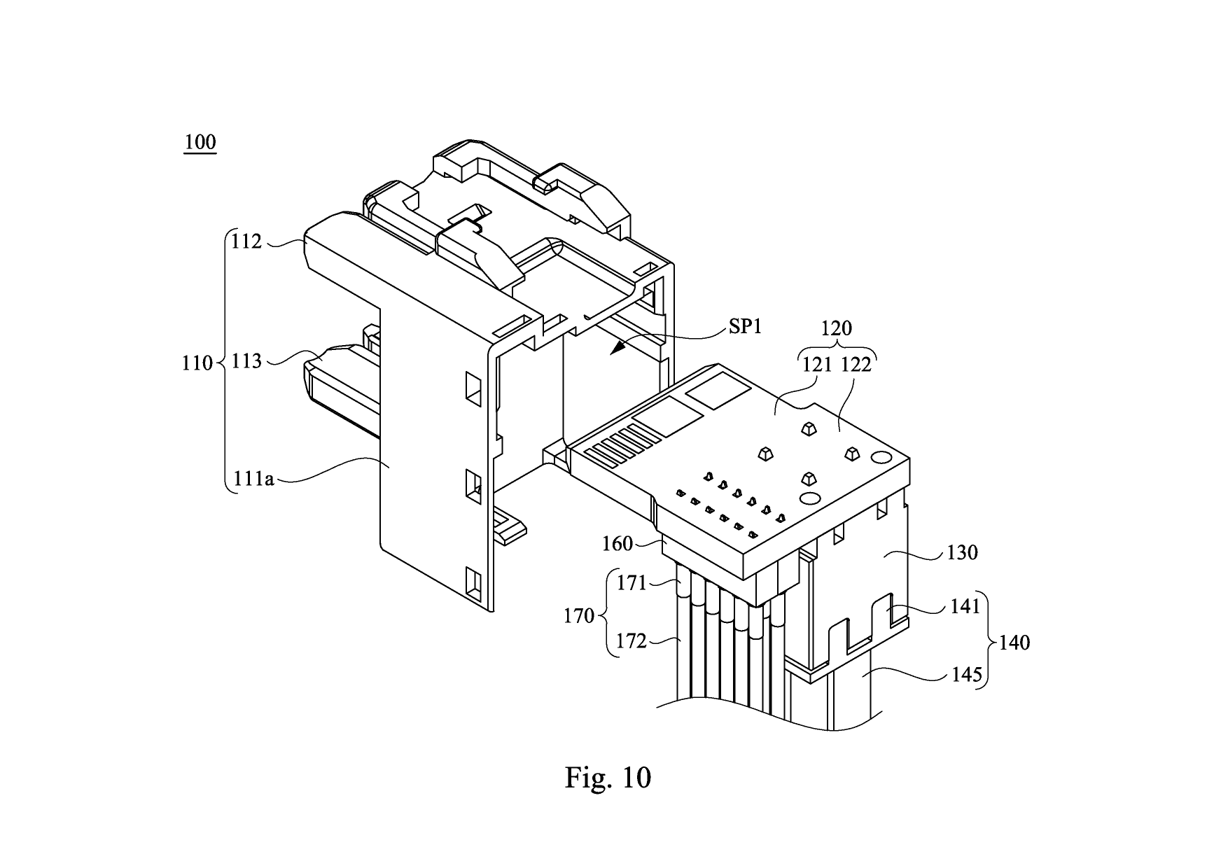

Reference is made to FIG. 10. FIG. 10 is a schematic view of the connector assembly 100 of FIG. 1, in which the printed circuit board 120 already disposed with the first cable module 140 and the second cable module 170 is ready to be connected to the first subsidiary body 111a. As shown in FIG. 10, after the printed circuit board 120 is disposed with the first cable module 140 and the second cable module 170 as described above, the assembly of the printed circuit board 120 with the first cable module 140 and the second cable module 170 is inserted into the first subsidiary body 111a of the housing 110, and the printed circuit board 120 at least partially penetrates through the first opening OP1 of the first subsidiary body 111a, such that the front portion 121 of the printed circuit board 120 extends out of the housing 110, as shown in FIGS. 1-2.

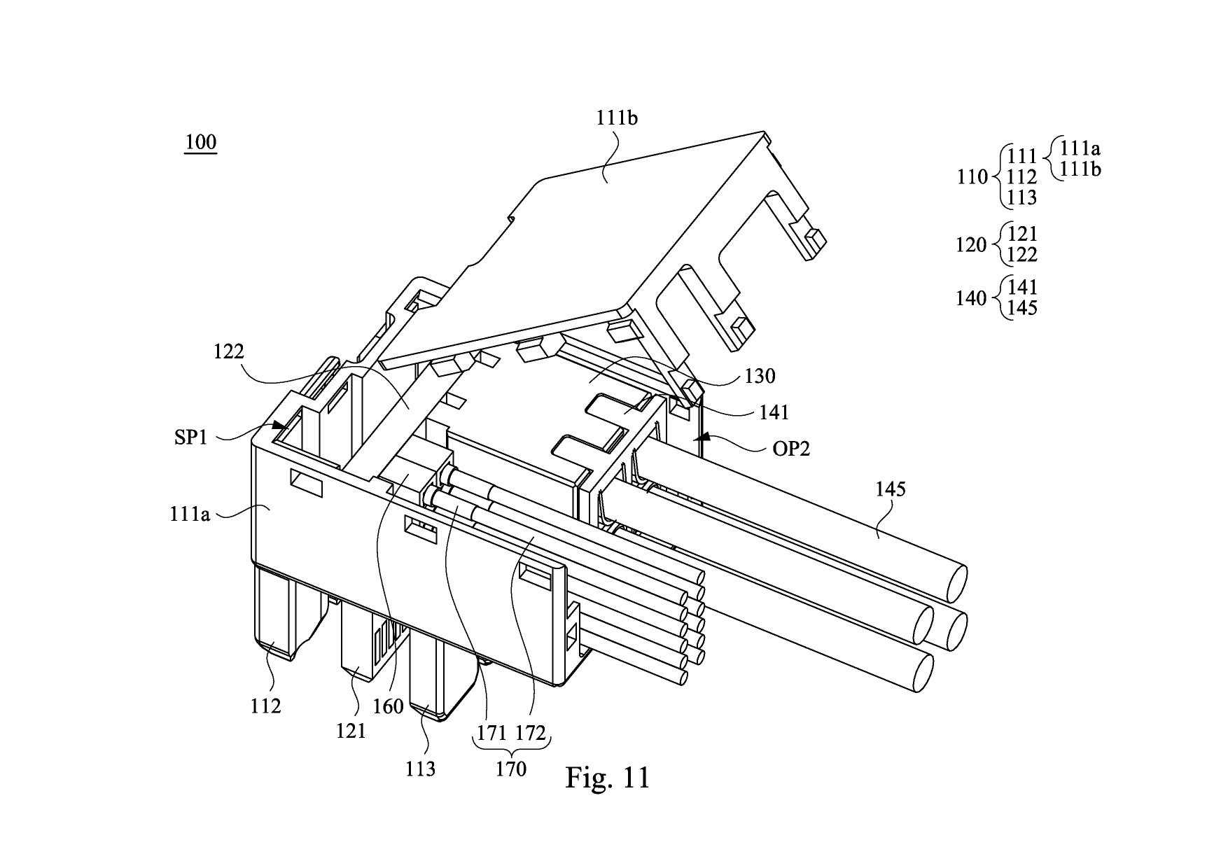

Reference is made to FIG. 11. FIG. 11 is a schematic view of the connector assembly 100 of FIG. 1, in which the second subsidiary body 111b is ready to be connected to the first subsidiary body 111a. As shown in FIG. 11, after the connection of the printed circuit board 120 disposed with the first cable module 140 and the second cable module 170 to the first subsidiary body 111a is completed, the second subsidiary body 111b is detachably connected with the first subsidiary body 111a to at least partially enclose the first space SP1. At this point, the assembly of the connector assembly 100 is completed, as shown in FIGS. 1-2.

It is worth to note that, as mentioned above, since the first socket 130 is secured to the printed circuit board 120 by the first terminals 132 abutting the printed circuit board 120 within the first through holes H1, and the second socket 160 is secured to the printed circuit board 120 by the second terminals 162 abutting the printed circuit board 120 within the second through holes H2, welding material is avoided to be used for these connections. Therefore, apart from achieving a saving of assembly time and cost, in case there is a schedule for the replacement of any one of the first socket 130 and/or the second socket 160, the operation can be carried out in a simple and easy manner.

Moreover, unlike the use of intermediate molded component around the connection between the printed circuit board and each of the sockets in a traditional connector assembly, in the present disclosure, the sockets (i.e., the first socket 130 and the second socket 160) and the printed circuit board 120 are respectively free from any intermediate molded component located in the first space SP1 of the housing 110. Therefore, apart from achieving a saving of assembly time and cost, in case there is a schedule for the replacement of any one of the first socket 130, the first cable(s) 145, the second socket 160 and/or the second cable(s) 172, the operation can be carried out in a simple and easy manner.

In conclusion, the aforementioned embodiments of the present disclosure have at least the following advantages:

(1) Since the first socket is secured to the printed circuit board by the first terminals abutting the printed circuit board within the first through holes, and the second socket is secured to the printed circuit board by the second terminals abutting the printed circuit board within the second through holes, welding material is avoided to be used for these connections. Therefore, apart from achieving a saving of assembly time and cost, in case there is a schedule for the replacement of any one of the first socket and/or the second socket, the operation can be carried out in a simple and easy manner.

(2) Unlike the use of intermediate molded component around the connection between the printed circuit board and each of the sockets in a traditional connector assembly, in the present disclosure, the sockets and the printed circuit board are respectively free from any intermediate molded component located in the first space of the housing. Therefore, apart from achieving a saving of assembly time and cost, in case there is a schedule for the replacement of any one of the first socket, the first cable(s), the second socket and/or the second cable(s), the operation can be carried out in a simple and easy manner.

Although the present disclosure has been described in considerable detail with reference to certain embodiments thereof, other embodiments are possible. Therefore, the spirit and scope of the appended claims should not be limited to the description of the embodiments contained herein.

It will be apparent to the person having ordinary skill in the art that various modifications and variations can be made to the structure of the present disclosure without departing from the scope or spirit of the present disclosure. In view of the foregoing, it is intended that the present disclosure cover modifications and variations of the present disclosure provided they fall within the scope of the following claims.

What is claimed is:

1. A connector assembly, comprising:
a housing having a first outer surface, a second outer surface, a first opening, a second opening and a first space, the first outer surface being adjacent and substantially perpendicular to the second outer surface, the first opening being located on the first outer surface, the second opening being located on the second outer surface, the first outer surface and the second outer surface together defining the first space;
a printed circuit board comprising a front portion and a rear portion connected with the front portion, the front portion extending out of the housing through the first opening and the rear portion being disposed in the first space;
a first socket detachably connected with the rear portion of the printed circuit board;
a first cable module comprising a first plug and a first cable, the first cable being connected with the first plug and extending out of the housing through the second opening, the first plug being detachably connected with the first socket;
a second socket detachably connected with the rear portion; and
a second cable module comprising a second plug and a second cable, the second cable being connected with the second plug and extending out of the housing through the second opening, the second plug being detachably connected with the second socket.

2. The connector assembly of claim 1, wherein the first cable is a power cable, the second cable is a low-speed signal cable.

3. The connector assembly of claim 1, wherein the first cable has a first diameter, the second cable has a second diameter, the first diameter is at least two times larger than the second diameter.

4. The connector assembly of claim 1, wherein the first socket and the second socket are spaced apart from each other.

5. The connector assembly of claim 1, wherein the housing comprises:
a main body having the first outer surface and the second outer surface;
a first insertion portion disposed on the first outer surface; and
a second insertion portion disposed on the first outer surface, the first opening is located between the first insertion portion and the second insertion portion.

6. The connector assembly of claim 5, wherein the main body comprises:
a first subsidiary body having the first outer surface and defining the first space; and
a second subsidiary body detachably connected with the first subsidiary body to at least partially enclose the first space, the first subsidiary body and the second subsidiary body together define the second outer surface and the second opening therebetween.

7. The connector assembly of claim 5, wherein the first insertion portion and the second insertion portion are respectively spaced apart from the front portion.

8. The connector assembly of claim 1, wherein the first socket comprises:
a first base abutting against the rear portion;
a first terminal penetrating through the first base, the first terminal comprises a first end section and a second end section opposite to the first end section, the first end section inserts into and secures with the rear portion, the second end section inserts into the first plug and is detachably connected with the first cable;
two first sidewalls connected with the first base, the first sidewalls are opposite to each other; and
a second sidewall connected with the first base and connected between the first sidewalls, the first base, the first sidewalls and the second sidewall together define a second space, the second space at least partially accommodates the first plug.

9. The connector assembly of claim 8, wherein the first sidewalls and the second sidewall are arranged to at least partially form a U-shape.

10. The connector assembly of claim 8, wherein each of the first sidewalls has at least one locking hole, the first plug comprises:
a main portion, the first cable is connected with the main portion; and
at least a pair of locking protrusions disposed on opposite sides of the main portion, each of the locking protrusions snaps into a corresponding one of the locking holes.

11. The connector assembly of claim 10, wherein the main portion abuts against the first base, the first sidewalls and the second sidewall.

12. The connector assembly of claim 8, wherein the rear portion has a first through hole, the first end section inserts into the first through hole, the first end section comprises:
a first root connected to the second end section;
a first tip; and
two first curved arms respectively connected between the first tip and the first root, the first curved arms are curved away from each other to abut against the rear portion within the first through hole.

13. The connector assembly of claim 8, wherein the rear portion has a plurality of positioning holes, the first socket further comprises a plurality of positioning protrusions disposed on the first base, the positioning protrusions insert into the positioning holes.

14. The connector assembly of claim 1, wherein the rear portion has a second through hole, the second socket comprises:
a second base abutting against the rear portion and having a third through hole; and
a second terminal comprising:
a fixing portion located in the third through hole and detachably connected with the second plug; and
a connecting portion connected with the fixing portion and inserting into the second through hole to secure with the rear portion.

15. The connector assembly of claim 14, wherein the connecting portion comprises:
a second root connected to the fixing portion;
a second tip; and
two second curved arms respectively connected between the second tip and the second root, the second curved arms are curved away from each other to abut against the rear portion within the second through hole.

16. A connector assembly, comprising:
a housing having a first opening, a second opening and a space communicated with the first opening and the second opening;
a printed circuit board disposed in the space, at least a portion of the printed circuit board extending out of the housing through the first opening;
a first socket disposed in the space and detachably connected with the printed circuit board;
a first plug detachably connected with the first socket;
a plurality of power cables connected with the first plug and extending out of the housing through the second opening;
a second socket disposed in the space and detachably connected with the printed circuit board;
a second plug detachably connected with the second socket; and
a low-speed signal cable connected with the second plug and extending out of the housing through the second opening,
wherein the first socket and the printed circuit board are free from any intermediate molded component located in the space, and
wherein the second socket and the printed circuit board are free from any intermediate molded component located in the space.
